(19) United States
(12) Patent Application Publication
(10) Pub. No.: US 2011/0182074 A1
(43) Pub. Date: Jul. 28, 2011

(54) LAMP WITH AT LEAST ONE LIGHT-EMITTING DIODE

(76) Inventor: Michael Hemerle, Marktredwitz (DE)

(21) Appl. No.: 13/119,195

(22) PCT Filed: Sep. 17, 2009
(86) PCT No.: PCT/EP2009/062046

§ 371 Date: Apr. 8, 2011

(30) Foreign Application Priority Data
Sep. 22, 2008 (DE) 102008042257.6

(51) Int. Cl. F21V 29/00; F21V 3/04; F21V 3/00

(52) U.S. Cl. 362/294; 362/257; 362/311.02

(57) ABSTRACT

A lamp has at least one light emitting diode (LED) as a illumination means, and a lamp body with a shield surrounding the LED and a socket holding the LED. The lamp body of the lamp is entirely a ceramic material.

The invention relates to a lamp having at least one light-emitting diode (LED) that is arranged on a base and is surrounded by a shade-type body as a cooling body. The base and the shade can consist of a ceramic material.

From the point of view of saving energy, conventional luminous elements are being replaced, to an increasing extent, by LEDs. The higher the light-output is raised, however, the higher the loss as a result of radiated heat rises. This is the case particularly with high-power LEDs. For example, an LED with an input power of 4 watts at 1 ampere delivers a radiation energy of 1.2 watts as light; 2.8 watts are lost as heat that must be dissipated. A so-called high-power solid-state luminaire is known from DE 112006001536 T5. In order to discharge the heat that is generated by the LED, a metallic reflector is backed with a porous ceramic material, this necessitating an expensive construction.

An object of the invention is to put forward an LED lamp with a simple structure.

The lamb in accordance with the invention consists of a base and a shade that surrounds the at least one LED. Accommodated in the base there are the conductors, the anode conductor and the cathode conductor, and these lead to the surface of the base on the side facing the shade. The LED can have an SMD (surface mounted device) housing with which it is soldered with its terminals onto the conductors on the base. If the LED is wired, the connection of the LED to the anode conductor and the cathode conductor, apart from being effected by soldering, can also be effected in the way that is described further below with reference to an exemplary embodiment.

The shade that surrounds the LED has three functions. It protects the LED from damage, and as a result of its colour configuration it has an influence upon the colour of the light that is radiaed. In the main, however, it is used as a heat sink, that is, to discharge the heat that is generated by the LED to the surrounding air. In order to enlarge the surface, the shade can have formations distributed over its periphery, such as, for example, ribs, the cross sections of which can have any forms. Even the form of the shade can be of any kind. Apart from being round, it can, for example, be polygonal, oval or elliptic.

The body of the lamp can be in one part or two parts, that is, consisting of a base with a shade set thereon. In this connection, the shade can be glued together with the base or be fixedly connected thereto in another way. This type of construction is particularly advantageous if LEDs with SMD housings are to be soldered on the base, because as a result the soldering points are freely accessible before the base and shade are assembled.

The material of the lamp must be heat-resistant. A particularly suitable material for the lamp is a ceramic material with good thermal conductivity, for example aluminium oxide, containing glass or pure, with or without additives, for example Cr₂O₃, with a thermal conductivity of 20 to 40 W/m° K, or aluminium nitride with a thermal conductivity of 160 to 200 W/m° K. Depending on the intended illumination effect, the material can be see-through or transparently translucid, translucent. The breaking strength of the ceramic materials should lie between 100 and 1000 MPa.

The basic colour of the ceramic material is white or clear like glass. By means of appropriate additives, which are known from the prior art, added to the ceramic material, the ceramic material can also be coloured. By combining LEDs that emit white or coloured light with corresponding ceramic material, different colour effects can be attained. Furthermore, the shade can have a light-permeable cover over the LED which can be clear or coloured. The following colour compositions are possible:
The light of the LED has the basic colour white; the ceramic material is white or glass-like.
The light of The LED has the basic colour white; the ceramic material is coloured.
The light of the LED is coloured; the ceramic material is white or glass-like.
The light of the LED is coloured; the ceramic material is coloured.
The light of the LED has the basic colour white, the ceramic material is white or glass-like, and the cover over the LED is colourless.
The light of The LED has the basic colour white, the ceramic material is white or glass-like, and the cover over the LED is coloured.
The light of the LED has the basic colour white, the ceramic material is coloured, and the cover over the LED is colourless.
The light of the LED is coloured, the ceramic material is white or glass-like, and the cover over the LED is colourless.
The light of the LED is coloured, the ceramic material is coloured, and the cover over the LED is colourless.
The light of the LED is coloured, the ceramic material is coloured, and the cover over the LED is coloured.

The bases of the lamp bodies can also be equipped as plugs to establish plug connections with corresponding plug sockets or with threads for screwing into holding supports or, in the case of bases occupied with terminal poles, into lamp holders.

The invention is explained in greater detail with the aid of exemplary embodiments. In the drawings:

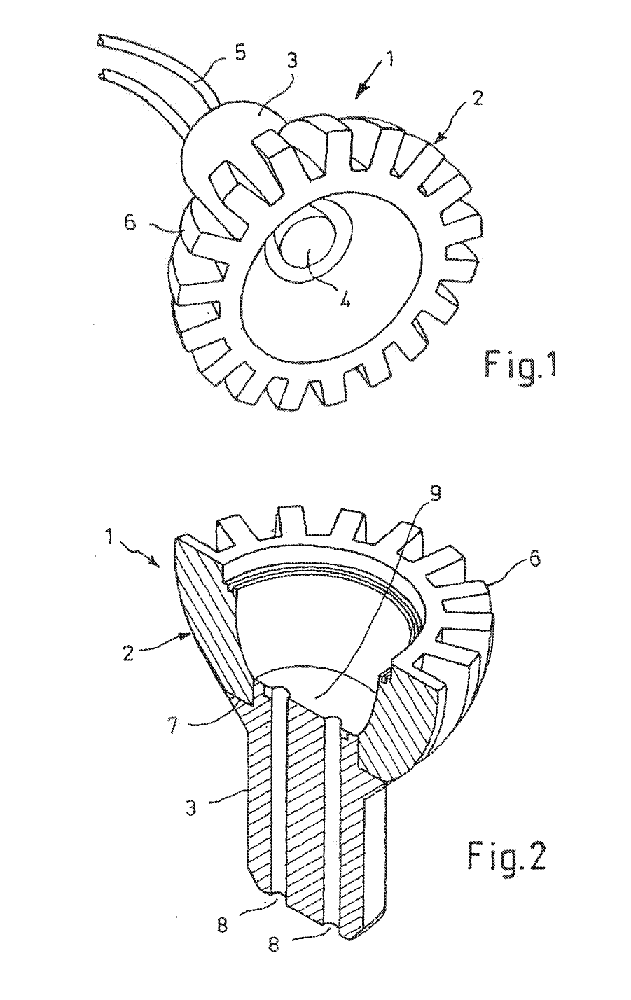

FIG. 1 shows a view of an embodiment of the lamp in accordance with the invention with a lamp body made from ceramic material;

FIG. 2 shows a longitudinal section through a two-part lamp body according to FIG. 1 in a perspective view;

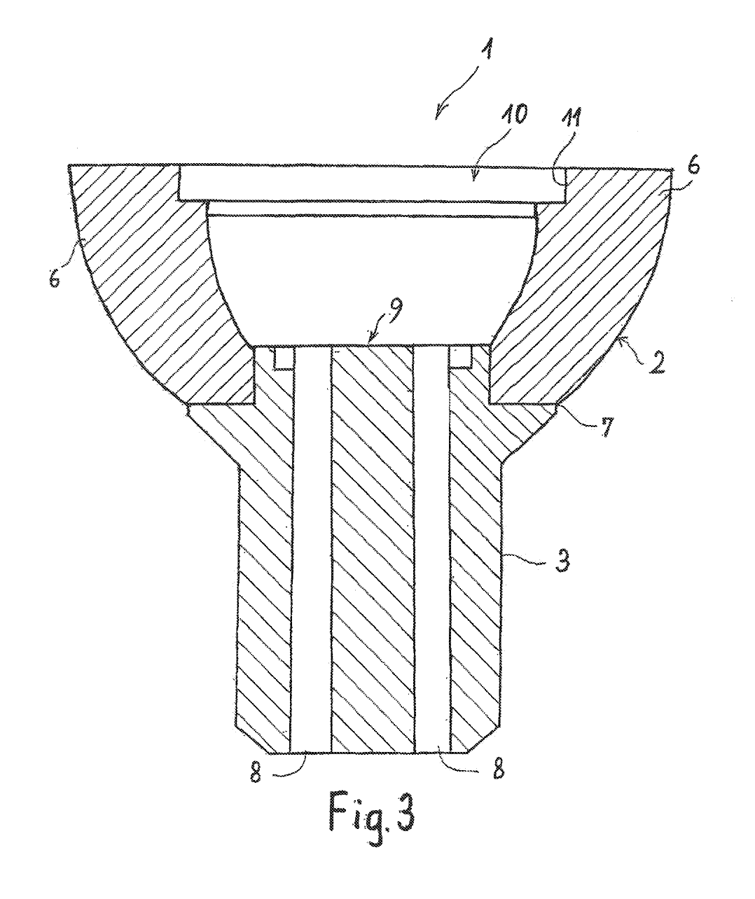

FIG. 3 shows the view of the longitudinal section through a two-part lamp body according to FIG. 1;

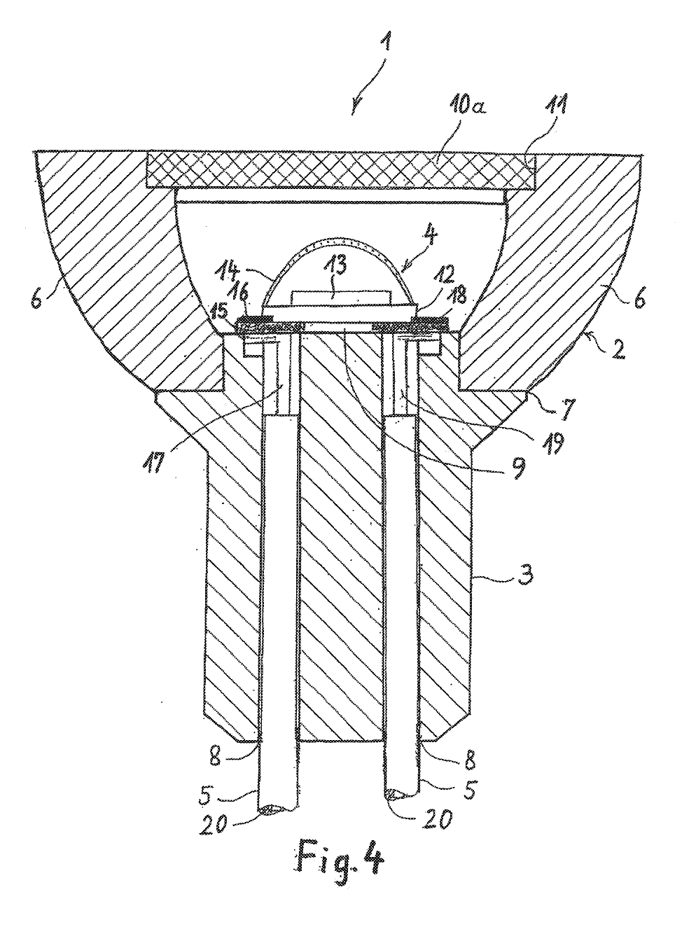

FIG. 4 shows a longitudinal section through a two-part lamp body according to FIG. 1 with an LED soldered thereon in the SMD housing and with a cover;

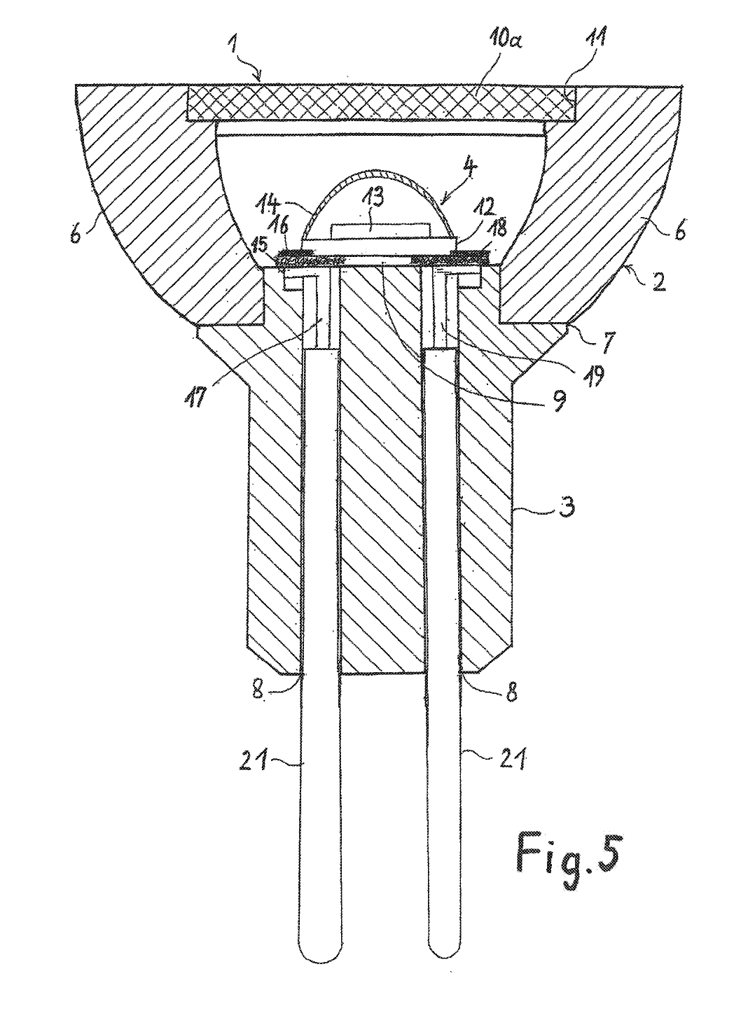

FIG. 5 shows an embodiment according to FIG. 4 with plug-in terminals;

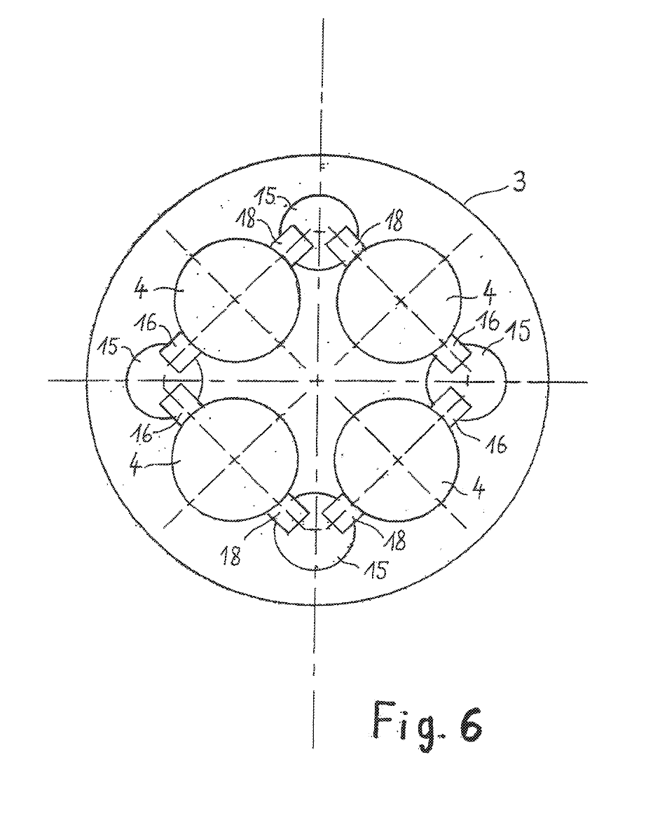

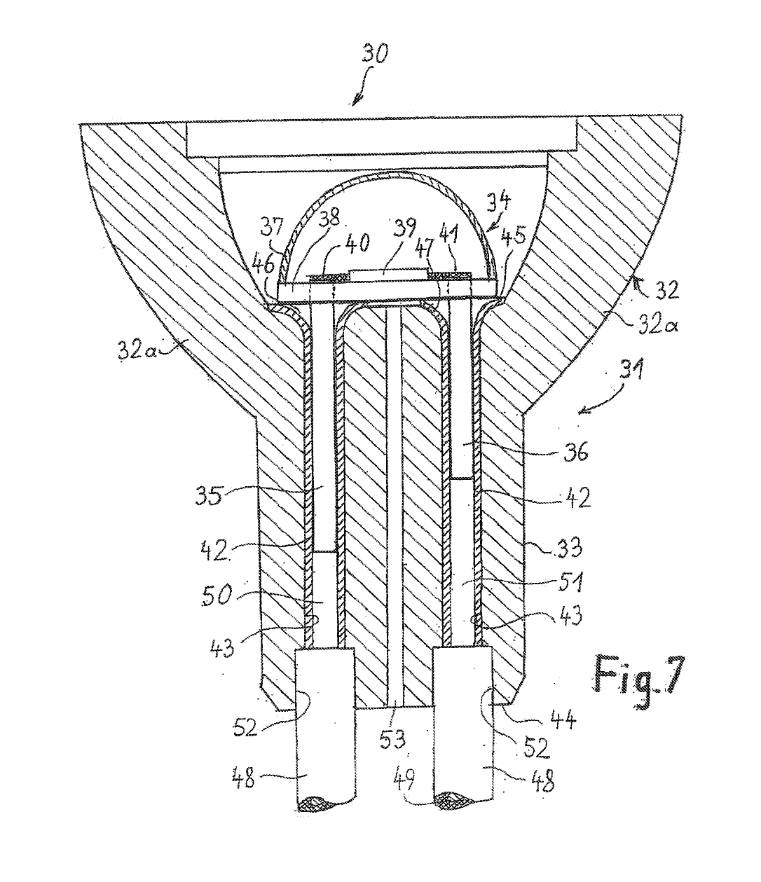

FIG. 6 shows a plan view of a lamp base with multiple LED fitting;

FIG. 7 shows a longitudinal section through a one-piece ceramic body of the lamp for an exchangeable, wired LED;

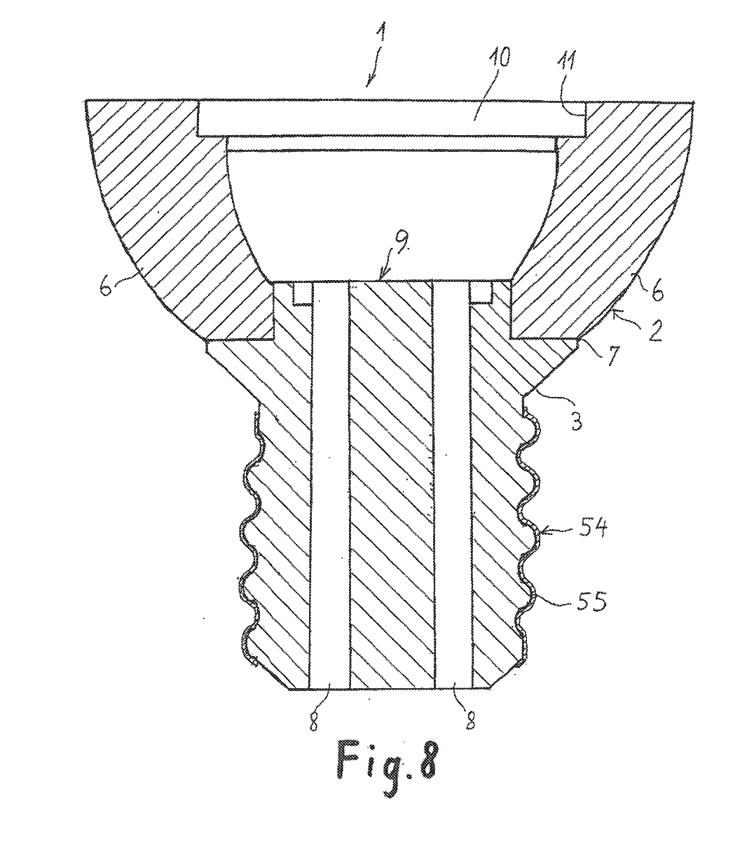

FIG. 8 shows a lamp base with a thread for screwing into a holding support;

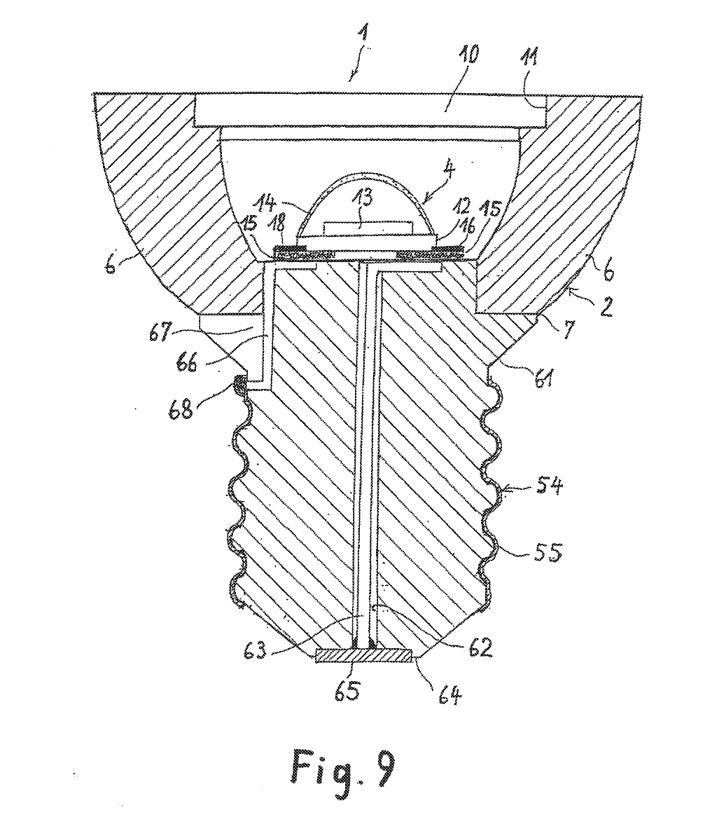

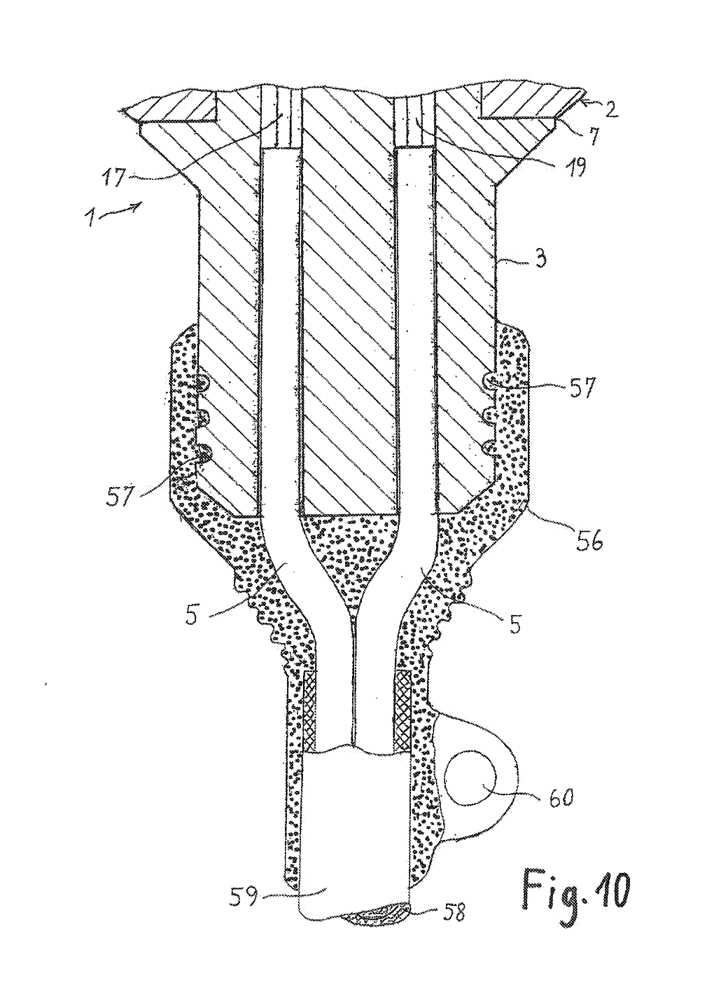

FIG. 9 shows a lamp base with a standard thread for screwing into a lamp holder;

FIG. 10 shows a lamp base with strain relief for the terminal conductors.

FIG. 1 shows the picture of an exemplary embodiment of a lamp 1 in accordance with the invention. The shade 2 and the base 3 form the lamp body and consist of white, translucid ceramic material. The material can, in the case of LEDs of low output and heat-emission, also consist of a heat-resistant plastics material. The light-emitting diode (LED) 4 that is arranged centrally in the lamp shade 2 radiates white light in the present exemplary embodiment. The terminal conductors 5 of the LED 4 issue from the underside of the base 3. The shade 2 has cooling ribs 6 uniformly distributed over its periphery so that the outline of the shade 2 at its opening looks like a toothed wheel. The cooling ribs are advantageous, in particular in the case of high-power LEDs, in order to dissipate the heat that develops to the surrounding air. Their cross section can also assume any other possible form, such as, for example, a half-round or half-elliptic form. In the case of LEDs with low heat losses the shade can also be smooth. The shade can likewise have different forms, for example oval or polygonal form.

FIG. 2 shows a section through the lamp body of the lamp 1 in a perspective view. The section extends in each case through cooling ribs 6. The shade 2 and the base 3 are glued together on their periphery at the contact point 7. The base 3 has two channels 8 through which the terminal conductors 5, visible in FIG. 1, the anode conductor and the cathode conductor, are guided to the terminal point 9 of the LED 4.

FIG. 3 shows a view in longitudinal section through the lamp body of the lamp 1. The section extends on the left-hand and on the right-hand side through a respective cooling rib 6. In the opening 10 of the shade 2 there is a recess 11, into which a cover for the protection of the LED, not shown here, can be inserted. This cover can, for example, be of glass or plastics material and, in coordination with the colour of the LED and the ceramic material, can be coloured or clear.

FIG. 4 shows a longitudinal section through the lamp body of the lamp 1 with an LED 4 soldered thereon with an SMD housing. The shade is closed by a cover 10a. The colour of the cover 10a can be selected in accordance with the desired colour of the light. The LED 4 is shown diagrammatically here. Applied to a substrate 12, for example of ceramic material, there is the luminescent-material layer 13 that is protected by a lens 14, shown in section, that is made, for example, of glass. At the intended point 9 the LED 4 is soldered, at the soldering points 15, with its anode terminal 16 onto the anode conductor 17 and with its cathode terminal 18 onto the cathode conductor 19. The terminal conductors 5 are guided through the channels 8 in the base 3 as far as the soldering points 15 and there freed of their insulation 20. In order to distinguish between the anode terminal and the cathode terminal, either the terminal conductors 5 can have different coloured insulation or a corresponding indication is provided on the base 3. The terminal conductors 5 can be glued in the channels 8 for the purposes of strain relief.

FIG. 5 shows an exemplary embodiment of a lamp according to FIG. 4, which can be pushed with its base 3 into a plug connection, a plug. For the purposes of plugging into a plug connection, instead of elastic conductors solid metal pins 21 are inset as plug contacts for the production of the terminal in the base 3. For the purposes of introduction into a plug connection, for example into a wall socket, into a plug socket of a terminal line or into a plug bushing of a chain of lights, the base 3 itself can have the necessary external form therefor, in a way that is not shown here.

FIG. 6 shows a plan view of a base 3 with a multiple fitting with LEDs on an enlarged scale in comparison with the previous representations. Features that correspond with the preceding exemplary embodiments are denoted by the same reference numerals. The exemplary embodiment is a diagrammatic representation. Four LEDs 4 are arranged on the upper side of the base 3. In this connection, the anode terminals 16 and the cathode terminals 18 of two adjacent LEDs are in each case soldered on at a common soldering point 15. Either the base 3 then contains, in a way that is not shown here, four terminal conductors, two anode conductors 17 and two cathode conductors 19, or in each case two soldering points 15 of the anode terminals 16 and the cathode terminals 18 are connected together by means of printed conductors on the surface of the base 3, in a way that is not shown here, so that it is possible to use the original form of the base 3 with two channels 8.

A further embodiment 30 of the lamp in accordance with the invention is shown in FIG. 7 in a longitudinal section. The difference with respect to the preceding exemplary embodiments lies in the fact that the lamp body 31 is in one piece. The shade 32 and the base 33 form a unit. The section also extends here through the cooling ribs 32a of the shade 32. This exemplary embodiment is suitable in particular for wired LEDs 34. In the case of wired LEDs the anode terminal 35 and the cathode terminal 36 in wire form are guided out of the LED body. In FIG. 7 the lens 37 of the LED 34, which is diagrammatically represented, is in section and shows the basic body 38 with the luminescent-material layer 39, of which the anode 40 is connected to the anode terminal 35 and the cathode 41 connected to the cathode terminal 36.

In the present exemplary embodiment the lamp 30 is configured in such a way that the LED 34 can be exchanged. For this, the anode terminal 35 and the cathode terminal 36 are each pushed into small tubes 42 inserted into the base 33 therefor and adapted to the terminals. These small tubes 42 are plugged in channels 43 and extend continuously from the bottom 44 of the base 33 as far as the upper end 45 of the base 33. There, where the small tubes 42 penetrate the upper end 45 of the base 33, the openings 46 in the base 33 are formed conically in such a way that the ends 47 of the small tubes 42 can be widened in a correspondingly conical manner. As a result, they are protected in the base 33 against being extracted in the event of tensile loading of the terminal conductors 48. Moreover, the pushing-in of the LED terminal wires is facilitated by the conically widened small tubes 42.

Before the small tubes 42 are introduced into the base 33 and widened in the openings 46, the terminal conductors 48 are connected to the small tubes. For this, the terminal conductors 48 are freed of their insulation 49, and the anode conductor 50 and the cathode conductor 51 are soldered into the corresponding small tubes 42 and the latter are subsequently introduced into the base 33. For the purposes of protection against contacting metallically bare terminals, the terminal conductors 48 can be introduced with their insulation 49 into recesses 52 of the base 33. In order to increase the security against extraction, the terminal conductors 48 can additionally be glued in these recesses 52.

As known, wired LEDs have terminal wires of differing length so that the anode and cathode cannot be mixed up. The cathode terminal 36 is shorter than the anode terminal 35. In order, in the case of the present exemplary embodiment, to prevent the interchange of the terminals of the LED when plugging into the small tubes, the anode conductor 50 and the cathode conductor 51 are each introduced so far into the small tubes 42 that when the terminals 35 and 36 are completely pushed into the small tubes 42 and when the LED 34 rests completely against the upper end 45 of the base 33, the anode terminal 35 strikes against the anode conductor 50 and the cathode terminal 36 strikes against the cathode conductor 51. If the LED were pushed into the small tubes with interchanged terminals, the longer anode terminal 35 would strike against the longer cathode conductor 51. The LED would therefore stand out from the upper end 45 of the base 33, this being an indication of the fact that the terminals were the wrong way round.

A lamp with an exchangeable LED can also be a possibility in the case of an embodiment with a plug terminal, as shown in FIG. 5. The solid plug contacts 21 would then have to have bores adapted in length to the anode terminal and the cathode terminal.

In order to facilitate the exchange of an LED 34, the base 33 can have a centrally arranged, continuous bore 53 which ends underneath the basic body 38 of the LED 34. If a correspondingly thin body, for example a wire, is pushed through this bore 53, the anode terminal 35 and the cathode terminal 36 can be extracted from the small tubes 42.

FIG. 8 shows an embodiment of a lamp body according to FIG. 3, in section, with a base 3 which on its outer face bears a thread 54 for screwing into a screw-type socket of a holding support that is not shown here, for example in a piece of furniture or a display case. In a way that is not shown here, the thread 54 can also be fitted on the base of a one-piece lamp body in accordance with the exemplary embodiment according to FIG. 7. In order to protect the ceramic material, the thread 54 can be covered with a correspondingly formed sheet-metal sleeve 55.

In accordance with the exemplary embodiments according to FIGS. 4 and 8, FIG. 9 shows a lamp 1 with a lamp base 61, the thread 55 of which is suitable for screwing into standard holders and which is used for the current supply. Features that correspond with the preceding exemplary embodiments are denoted by the same reference numerals. The base 61 here is also equipped with a thread 54 which is surrounded by a correspondingly formed metallic sleeve 55. In contrast with the bases according to FIGS. 4 and 8 the base 61 has a centrally arranged channel 62 through which the anode conductor 63 extends and is connected at the soldering point 15 to the anode terminal 16 of the LED 4. At the lower end 64 of the base 61 the anode conductor 63 is soldered on a contact plate 65 which establishes the contact with the corresponding voltage-conducting pole in the holder. The cathode terminal 18 of the LED 4 is connected to the cathode conductor 66 at the soldering point 15. The cathode conductor 66 is guided outwards through a correspondingly configured gap 67 in the base 61 and is connected. at the soldering point 68 to the sleeve 55 which in a lamp holder establishes the contact with the corresponding voltage-carrying pole. The embodiment shown here is used for connection to a correspondingly poled direct-current network. For the purposes of connection to an alternating-current network, the lamp must, in a manner that is not shown here, be equipped with a rectifier circuit arrangement.

A base of a lamp body according to FIG. 3 or 4 that is equipped with strain relief 56 for the terminal conductors 5, is shown in section in FIG. 10. The base 3 and terminal conductors fare surrounded by a correspondingly formed elastomer, for example rubber, that offers protection against extraction of the terminal conductors 5. The strain relief 56 can, for example, also be used as part of a chain of lights, which is not shown here, for receiving the lamp body. For better anchorage of the strain relief 56 at the base 3, the latter can be provided with grooves 57 arranged on its periphery. The two terminal conductors 5 can either be guided out of this strain relief 56 separately or, as shown here, combined to form a common line 59 surrounded by a common insulation 58. In addition, an eyelet 60, for example for suspension or securement of the lamp body, can be pre-formed on the strain relief 56. In a way that is not shown here, the strain relief 56 can also be fitted on the base of a one-piece lamp body in accordance with the exemplary embodiment according to FIG. 7.

Developments of the invention are described in the following:

1. A lamp in accordance with the invention, characterised in that the light of the LED (4, 34) is white.

2. A lamp in accordance with the invention, characterised in that the light of the LED (4, 34) is coloured.

3. A lamp in accordance with the invention, characterised in that the ceramic material at least of the shade (2, 32) is coloured, and in that the light of the LED (4, 34) is white.

4. A lamp in accordance with the invention, characterised in that the ceramic material at least of the shade (2, 32) is coloured, and in that the light of the LED (4, 34) is coloured.

5. A lamp in accordance with the invention, characterised in that the shade (2, 32) has a light-permeable cover (10a) over the LED (4, 34) that is colourless.

6. A lamp in accordance with the invention, characterised in that the shade (2, 32) has a light-permeable cover (10a) over the LED (4, 34) that is coloured.

7. A lamp in accordance with the invention, characterised in that the base (3, 33, 61) has channels (8, 43, 62) for the terminal conductors (5, 48, 63) of the LED (4, 34).

8. A lamp in accordance with the invention, characterised in that the at least one LED (4) has an SMD housing and on the base (3, 61) at the point (9) provided therefor is soldered, at the soldering points (15), with its anode terminal (16) onto the anode conductor (17; 63) and with its cathode terminal (18) onto the cathode conductor (19; 66) of the terminal conductors (5).

9. A lamp in accordance with the invention, characterised in that the at least one LED (34) is a wired LED and is exchangeable.

10. A lamp in accordance with the invention, characterised in that the anode terminal (35) and the cathode terminal (36) of the LED (34) are each pushed into small tubes (42) inserted in the base (33) therefor and adapted to the terminals, wherein these small tubes (42) are plugged in channels (43) in the base (33) and extend continuously from the bottom (44) of the base (33) as far as the upper end (45) of the base (33).

11. A lamp in accordance with the invention, characterised in that at that point where the small tubes (42) penetrate the upper end (45) of the base (33), the openings (46) of the channels (43) are formed conically, and in that the ends (47) of the small tubes (42) are conically widened in accordance with the openings (46).

12. A lamp in accordance with the invention, characterised in that the anode conductor (50) and the cathode conductor (51) of the terminal conductors (48) are each introduced so far into the small tubes (42) and soldered there that when the anode terminal (35) and the cathode terminal (36) are completely pushed into the small tubes (42) and when the LED (34) rests completely against the upper end (45) of the base (33), the anode terminal (35) strikes against the anode conductor (50) and the cathode terminal (36) strikes against the cathode conductor (51).

13. A lamp in accordance with the invention, characterised in that the base (33) has a continuous bore (53) which ends underneath the LED (34) for pushing the LED out of the small tubes (42).

14. A lamp in accordance with the invention, characterised in that the base (3, 61) has a thread (54).

15. A lamp in accordance with the invention, characterised in that the thread (54) is protected by a correspondingly formed sheet metal sleeve (55).

16. A lamp in accordance with the invention, characterised in that the sheet-metal sleeve (55) on the base (61) surrounds a thread (54) that is used for screwing into a standardized holder that is used for the current supply, in that the lower end (64) of the base (61) centrally bears a contact plate (65) for making contact with a voltage-conducting pole of the holder, and in that this contact plate (65) and the sleeve (55) are each connected to the terminals (16, 18) of the LED (4) by way of conductors (63, 66).

17. A lamp in accordance with the invention, characterised in that the base (3) is provided with strain relief (56) for the terminal conductors (5).

18. A lamp in accordance with the invention, characterised in that the strain relief (56) consists of an elastomer.

19. A lamp in accordance with the invention, characterised in that the strain relief (56) has an eyelet (60).

1-14. (canceled)

15. A lamp having at least one light emitting diode (LED) as a luminous means, consisting of a lamp body having a shade surrounding the LED and having a base bearing the LED, wherein the lamp body of the lamp consists completely of a ceramic material.

16. A lamp according to claim 15, wherein the lamp body of the lamp is composed of the two components shade and base.

17. A lamp according to claim 15, wherein the lamp body of the lamp that is formed from the shade and the base is in one piece.

18. A lamp according to claim 15, wherein the shade has cooling ribs.

19. A lamp according to claim 18, wherein the cooling ribs are arranged on the outer periphery of the shade.

20. A lamp according to claim 15, wherein the material of the lamp body of the lamp consisting of the shade and the base is a ceramic material.

21. A lamp according to claim 20, wherein the ceramic material has a breaking strength of 100 MPa to 1000 MPa.

22. A lamp according to claim 20, wherein the ceramic material has a thermal conductivity of 20 W/m° K to 40 W/m° K.

23. A lamp according to claim 22, wherein thee ceramic material is aluminum oxide.

24. A lamp according to claim 20, wherein the ceramic material has a thermal conductivity of 160 W/m° K to 200 W/m° K.

25. A lamp according to claim 24, wherein the ceramic material is aluminium nitride.

26. A lamp according to claim 15, wherein the ceramic material of the shade is transparent, translucid, translucent.

27. A lamp according to claim 15, wherein the ceramic material of the shade is see-through.

28. A lamp according to claim 15, wherein the ceramic material of the shade is white or clear like glass.
